(19) United States
(12) Patent Application Publication
(10) Pub. No.: US 2005/0114211 A1
(43) Pub. Date: May 26, 2005

(54) System and method for preventing coupon fraud

(76) Inventor: Kamran Amjadi, Bethesda, MD (US)

Correspondence Address: PILLSBURY WINTHROP, LLP, P.O. BOX 10500, MCLEAN, VA, 22102, US

(21) Appl. No.: 10/959,566

(22) Filed: Oct. 7, 2004

Related U.S. Application Data
(60) Provisional application No. 60/508,880, filed on Oct. 7, 2003.

(51) Int. Cl. G06F 17/60

(52) U.S. Cl. 705/14

(57) ABSTRACT

A system and method is provided for preventing coupon fraud. Discount incentives, such as coupons, are examined at the point of sale to determine if the incentive has been altered. The invention also provides a discount incentive having enhanced security feature, such as embedded authentication data. The embedded authentication data may be viewed using a decoder to determine the validity of the incentive.

### FIELD OF INVENTION

This invention relates to reducing alteration and unauthorized duplication of incentives by verifying the authenticity of the incentive at the point of sale.

### BACKGROUND

Incentives are distributed to consumers in the form of coupons or discount incentives, for example, with the goal of attempting to influence purchasing behavior of customers. For example, customers may be enticed to try new products or to switch product brands. Such incentives are typically made available to the general public through coupon packages in the mail or through electronic coupons provided online. In the case of electronic coupons, they may be printed and redeemed at a retail point of sale.

Discount incentives may be susceptible to fraud through from a variety of mechanisms including unauthorized duplication and/or alteration. For example, it may be possible for consumers to exceed discount amounts originally intended by manufacturers by adjusting discount amounts illustrated on the face of the coupons. In order to reduce incidences of fraud associated with discount incentives, measures may be taken to authenticate discount incentive information prior to redeeming them for value.

After discount incentives are redeemed for value, retailers may store the discount incentives and forward them to a clearinghouse for processing. The clearinghouse receives the discount incentives from many retailers and may sort them based on a multitude of manufacturers that are represented on the discount incentives. An operator at the clearinghouse may manually handle each of the received discount incentives. This handling may involve scanning or manually entering the Universal Product Code (UPC), which identifies information such as the manufacturer, product, and other information.

Once processed by the clearinghouse, the discount incentives are typically returned to the manufacturer for additional processing and eventual payment to the retailer. The manufacturer may sort the discount incentives received from the clearinghouse and may confirm that the redeemed coupons were provided by and/or authorized by the manufacturer. In order to settle on a payment amount, manufacturers and retailers must agree on a monetary amount associated with the redeemed coupons.

Typically, this is the stage where manufacturers review the redeemed coupons for indications of fraud. However, this may be too late. From the manufacturer's point of view, the examination for coupon fraud should occur by the retailer at the point of sale, in part, because the manufacturer has little leverage to withhold payment from retailers that accept and redeemed coupons presented by customers. If manufacturers withhold payments for coupons presented by customers, then the retailers may simply discontinue carrying the manufacturers' products in the future.

Other drawbacks exist with these and other known systems.

### SUMMARY OF THE INVENTION

According to various embodiments of the invention, a system and method are provided for preventing discount incentive by reducing alteration and/or unauthorized duplication of discount incentives. The system and method verifies the authenticity of incentives at the point of sale, thus preventing consumers from redeeming fraudulent coupons. Discount incentives, such as coupons, may have hidden information printed on its face that is only detectable by individuals having an appropriate decoder. The decoder enables retailers to verify the authenticity of the incentive at the point of sale, even where real time electronic validation is not available.

According to various embodiments of the invention, a system is provided for validating discount incentives. The system includes, among other components, a point of sales terminal and a central server. The point of sales terminal may include an optical scanner for retrieving information for images illustrated on the face of the discount incentive, and a decoder for retrieving hidden information. The central server may include a database for storing information about incentive validity and a processing module for evaluating validity and information a retailer at the point of sale whether or not the incentive is valid.

According to various embodiments of the invention, a discount incentive is provided having enhanced security features. Steganography or other data authentication methods may be used to hide an undetected message within the discount incentive. The discount incentive may include viewable security features as well as security features that are undetectable.

According to various embodiments of the invention, a decoder is provided for validating discount incentives having hidden authentication information. The decoder may include a key that is used to view portions of the discount incentive that are not detectable alone with the human eye. The decoder may be implemented alone to decode the authentication data, or may used in conjunction with an optical scanner.

According to various embodiments of the invention, a method is provided for performing real time electronic validation of discount incentives. A retailer at a point of sale may receive a discount incentive and scan a code located on the incentive. Information retrieved from the incentive may be transmitted to a central server which processes the information to determine the validity. The central server returns a decision to the retailer at the point of sale indicating whether or not the incentive is valid.

According to various embodiments of the invention, a method is provided for validating discount incentives having embedded authentication data at the point of sale. A retailer at a point of sale may receive a discount incentive having embedded authentication data which is not visible. The retailer may place a decoder over the incentive to bring the hidden authentication data into view. If the decoder indicates that the data is invalid, the retailer may disallow the incentive, and if the data is valid, the incentive may be redeemed.

These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below.

### BRIEF DESCRIPTION OF THE DRAWINGS

FIG. 1 illustrates a system for validating incentives, according to one embodiment of the invention.

FIG. 2 illustrates a discount incentive having authentication features, according to an embodiment of the invention.

FIG. 3 illustrates a decoder for discount incentives, according to an embodiment of the invention.

### DETAILED DESCRIPTION OF THE INVENTION

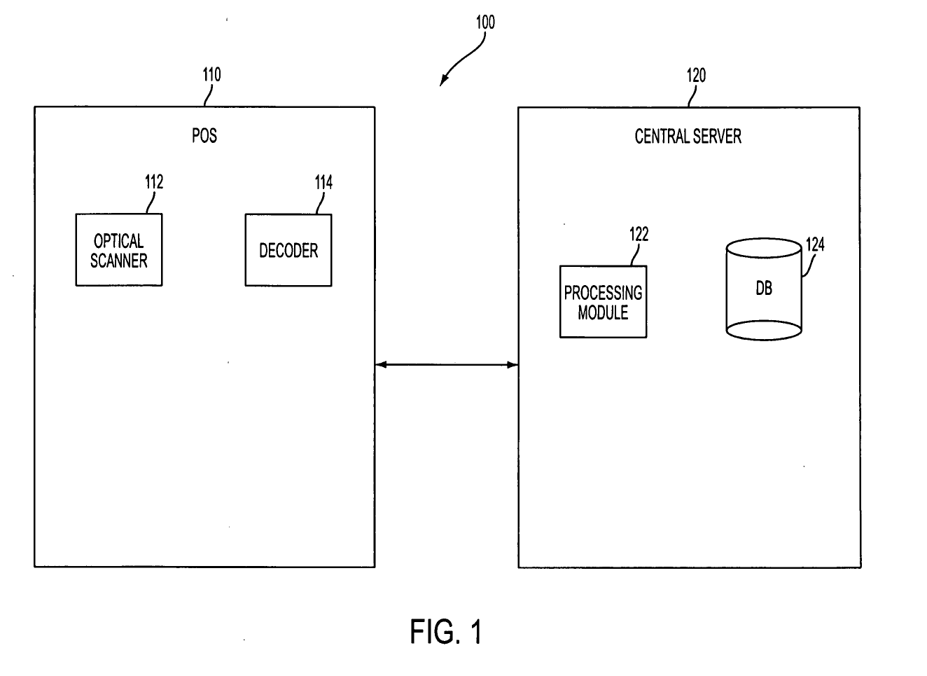

According to one embodiment of the invention, a system is provided for validating discount incentives. FIG. 1 illustrates an overall system diagram, according to this embodiment of the invention. System 100 may include a point of sales terminal 110. Point of sales (POS) terminal 110 may include an optical scanner 112, a decoder 300, and/or other point of sales devices. A customer wishing to redeem an incentive may present the incentive, along with the product for which the incentive is redeemable, to a retail clerk at POS 110. The retail clerk may scan the product using optical scanner 112. The retail clerk may also scan the incentive using optical scanner 112, in order to provide a discount to the customer. Scanning the incentive may, in some embodiments, cause information to be sent to central server 120. The information may include the date the incentive is being presented, the value of the incentive, the product for which the incentive is being redeemed, and/or other information.

Central server 120 may obtain a print activity code from the incentive to provide at least one indication of whether or not the scanned incentive is valid. Central server 120 may include a database 124 for storing information about available incentives. This information may include, for example, a print activity code, an incentive value, an incentive product description, and/or other information. Central server 120 may also include a processing module 122. Processing module 122 may be used to compare the information received from POS 110 and database 124 to determine validity. For example, central server 120 may confirm that the print activity code associated with the scanned discount incentive is valid. Furthermore, data derived from the discount incentives may provide an indication of whether or not the scanned discount incentives have been previously redeemed. If validated, the scanned discount incentives may be redeemed and the system updated accordingly. If discount incentives are determined to have already been redeemed by recognizing a print activity code, for example, the server may reject the discount incentives at the point of sale. Alternatively, the system may indicate that other aspects of the scanned discount incentives are not valid, such as the data associated with the scanned discount incentives. In these situations, the discount incentives may be deemed invalid.

Central server 120 may process and validate incentives in real time when a retail clerk scans the incentive and sends information to central server 120. Central server 120 may also provide validation information on a nightly, weekly, or otherwise scheduled time frame. Validation information may be distributed to retailers as scheduled, enabling retailers to validate any received incentives at the point of sale without sending the information to central server 120.

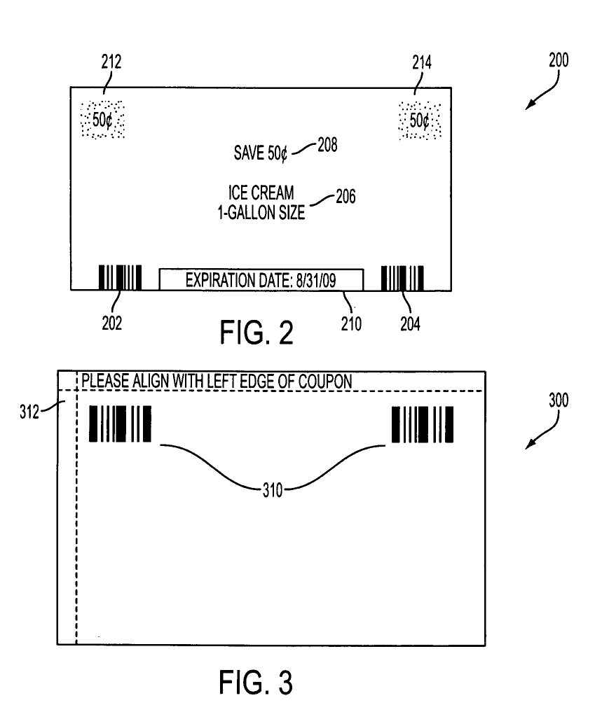

According to another exemplary embodiment of the invention, a discount incentive is provided having enhanced security features which reduce the use of fraudulent incentives. FIG. 2 illustrates an example of an incentive discount according to this embodiment of the invention. Incentive 200 may include, for example, a first UPC bar code 202 and a second bar code 204. Barcode 204 may include one or more user codes such as, for example user specific codes, coupon specific codes, print activity codes, and other codes. As illustrated, barcodes 202 and 204 may be detectable to the human eye. Incentive 200 may also include a description of the offer 206, a redemption amount 208, an expiration date 210, and/or other incentive information.

While examining the face of incentive 200 may indicate some alterations to the incentive, additional security features allow alterations to be detected that may not otherwise be visible. Authentication data may be incorporated with existing text, images, or other areas of the discount incentive. The authentication data may include, for example, information such as discount value, expiration date, user name, and/or other authenticating data. A process such as steganography may be used to hide the authenticating data within the other areas of the incentive. Other data hiding techniques may be used, as would be apparent.

According to one embodiment of the invention, a third UPC barcode and a fourth barcode may be hidden on the face of incentive 200. As illustrated in FIG. 2, series of dots 212 and 214 may be displayed on the face of incentive 200. These dots may be a third UPC barcode and a fourth barcode having certain pixels removed from the image, making the image unrecognizable as a barcode. While illustrated as a series of dots, other patterns may be used, as would be apparent. A decoder or bitmap may be formed corresponding to the images on incentive 200 that are missing selected pixels.

FIG. 3 illustrates a decoder, according to various embodiments of the invention. Placing the decoder over incentive 200 allows the pixel pattern on the decoder to complement the pattern on the discount incentive to produce a recognizable image. Decoder 300 may include a series of pixels 310 (or other indicia) corresponding to the pixels missing from incentive 200. An alignment guide 312 may be presented to properly align decoder 300 and incentive 200. While alignment guide 312 is illustrated on decoder 300, alignment guide may be placed on incentive 200 or on both incentive 200 and decoder 300. Decoder 300 and incentive 200 may tolerate a certain amount of noise that results from an imperfect overlay and/or an imperfect pixel pattern. According to one embodiment of the invention, the decoder may include a transparent background having pixels that complement the pattern associated with the discount incentive. For example, the decoder may include a Mylar sheet that overlays the discount incentive. A retailer may place the decoder over the discount incentive in order to create an image that is recognized to authenticate the discount prior to providing a cash reward.

According to various embodiments of the invention, decoder 300 may include a key coder associated with certain discount incentives. For example, a particular decoder may correspond with certain discount incentives. As a result, there may be a whole series of decoders that would correspond with a whole series of discount incentives. This may facilitate a security measure where certain decoders are canceled at regular intervals and replace with new decoders.

In various embodiments of the invention, the recognizable image formed may include information associated with the first UPC barcode, which may be an identical match to the information associated with the third UPC barcode. Similarly, the recognizable image may include information associated with the second bar code, which may be an identical match to information associated with the fourth barcode. If, upon scanning the barcodes, discrepancies exist among them, the discount incentive may be the subject of fraud. As a result, the retailer at the point of sale may be justified in refusing to redeem the discount incentive presented by the customer.

It should be readily understood by those skilled in the art that any type of data may be hidden using steganography. According to one embodiment of the invention, the decoder may enable authentication without needing to scan the incentive. The retailer may simply place the decoder over the discount incentive to make a determination of whether or not to pay the incentive. For example, a value on the face of the coupon may illustrate seventy-five cents, however a decoded value may illustrate fifty cents. Because the values do not match, fraud may be suspected. Other variables, such as name, print activity code, or other variables may be used instead of value.

According to various embodiments of the invention, the decoder may be implemented on an electronic machine to make the system quasi or fully electronic. For example, a layover may be implemented on the reader head of the scanner. In this case, the layover may be analogous to the manual method of laying the decoder over the discount incentive. For example, a mask on the reader may correspond to the mask of the decoder. Thus, a regular barcode reader may read the product information such as the UPC and other information. In some embodiments of the invention, an incentive may be scanned to obtain an image of the incentive that may be stored on a computer. The image may then be decoded, via the computer, using one or more known image processing techniques. For example, the image processing technique may be able to obtain information hidden within the incentive to determine whether or not the information has been altered or whether the incentive is a copy or a forgery.

While the preferred forms of the invention have been disclosed, it will be apparent to those skilled in the art that various changes and modification may be made that will achieve some of the advantages of the invention without departing from the spirit and scope of the invention. It will be apparent to those reasonably skilled in the art that other components performing the same function may be suitably substituted.

1. A method for detecting fraud in a discount incentive at a point of sale, the method comprising:
receiving, by a retailer located at the point of sale, a discount incentive having at least one visible security element and at least one non-visible security element;
using a decoder with the discount incentive to reveal at least one of the at least one non-visible security elements; and
comparing the at least one visible security element to the at least one revealed non-visible security element to determine whether the discount incentive is valid.

2. The method of claim 1, wherein:
the at least one visible security element includes a plurality of barcodes;
the at least one non-visible security element includes a plurality of barcodes; and wherein the method further comprises:
scanning one of the at least one visible security elements to retrieve first information;
scanning one of the at least one non-visible security elements to retrieve second information; and
comparing the first information to the second information to determine if the first and second information are the same.

3. The method of claim 1, wherein using a decoder with the discount incentive further comprises placing the decoder over the discount incentive to reveal at least one or the at least one non-visible security elements.

4. The method of claim 3, wherein placing the decoder over the discount incentive comprises aligning a guide on the decoder with a guide on the discount incentive.

5. The method of claim 1, wherein the decoder includes an optical scanner.

6. The method of claim 1 wherein the at least one non-visible security element includes an embedded image displaying a value of the discount incentive, and wherein the method further comprises:
revealing the embedded image using the decoder; and
comparing a value printed on the discount incentive with the revealed embedded image.

7. A discount incentive having hidden security features comprising:
a first barcode providing first information related to at least one of the set including: a value of the discount incentive and an expiration date for the discount incentive; and
indicia enabling a retailer to authenticate the information provided by the first barcode to validate the discount incentive.

8. The discount incentive of claim 7 wherein the indicia is a series of pixels.

9. The discount incentive of claim 7 wherein the series of pixels is a second barcode having one or more pixels removed from it.

10. The discount incentive of claim 8 further comprising a hidden image indicating a value of the incentive.

11. The discount incentive of claim 8 wherein at least one of the series of pixels and the hidden image is generated using a data hiding technique.

12. The discount incentive of claim 1 1 wherein the date hiding technique is steganography.

13. The discount incentive of claim 7 wherein the indicia is a series of lines representing a partial second barcode

14. The discount incentive of claim 8 wherein the indicia is a series of dots representing a partial second barcode.

15. A method of preventing the redemption of fraudulent discount incentives comprising:
receiving a discount incentive, the discount incentive comprising
a first barcode providing first information related to at least one of the set including: a value of the discount incentive and an expiration date for the discount incentive; and
first indicia enabling a retailer to authenticate the information provided by the first barcode to validate the discount incentive;
comparing information retrieved from the first barcode and the first indicia to determine if the information from the first barcode and the first indicia are the same; and
wherein the information from the first barcode and the first indicia are the same, redeeming the discount incentive; and
wherein the information from the first barcode and the first indicia are not the same, denying redemption of the discount incentive.

16. The method of claim 15 wherein the first indicia is a series of pixels.

17. The method of claim 16 wherein the series of pixels is a second barcode having one or more pixels removed from it.

18. The method of claim 17 wherein comparing information retrieved from the first barcode and the first indicia further comprises:
placing a decoder of the first indicia to reveal the second barcode;
scanning the first barcode; and
scanning the revealed second barcode.

19. The method of claim 18 wherein said decoder comprises a mylar sheet comprising second indicia to complement the first indicia.

20. The method of claim 18 wherein said decoder comprises a transparent sheet comprising second indicia to complement the first indicia.

21. The method of claim 15 wherein the discount incentive further comprises a hidden image indicating the value of the incentive, and wherein the method further comprises:
revealing the hidden image using a decoder; and
comparing a value printed on the discount incentive with the revealed hidden image.

22. The method of claim 1 wherein using a decoder to reveal at least one of the at least one non-visible security elements further comprises:
scanning the discount incentive to create an electronic image that is stored on a computer; and
performing a digital image processing operation on the discount incentive to reveal at least one of the at least one non-visible security elements.

23. A system for detecting fraud in a discount incentive at a point of sale, the system comprising:
means for receiving, by a retailer located at the point of sale, a discount incentive having at least one visible security element and at least one non-visible security element;
means for using a decoder with the discount incentive to reveal at least one of the at least one non-visible security elements; and
means for comparing the at least one visible security element to the at least one revealed non-visible security elements to determine whether the discount incentive is valid.
